(19) United States
(12) Patent Application Publication
(10) Pub. No.: US 2024/0152733 A1
(43) Pub. Date: May 9, 2024

(54) METHOD FOR GENERATING FILES

(71) Applicant: Ella Media AG, Zug (CH)

(72) Inventors: Katharina Wilbring, Köln (DE); Andreas Funke, Düsseldorf (DE); Nasrin Saef, Köln (DE)

(73) Assignee: Ella Media AG, Zug (CH)

(21) Appl. No.: 18/282,249

(22) PCT Filed: Mar. 14, 2022
(86) PCT No.: PCT/IB2022/052243

§ 371 Date: Sep. 15, 2023

(30) Foreign Application Priority Data
Mar. 16, 2021 (CH) 00280/21

(51) Int. Cl. G06N 3/0455; G06F 40/284

(52) U.S. Cl. CPC G06N 3/0455; G06F 40/284

(57) ABSTRACT

A method for generating files, in particular text and audio files as well as files for computer games or videos. The processing of very large quantities of texts, which differ in content and structure, is thereby ensured. For this purpose, existing data is filtered and processed (cleaned) in a first step, and subsequently a training corpus is generated from the processed data, which is adjusted to the desired results. The filtered and processed data is standardized.

### FIELD OF THE INVENTION

The invention relates to a method for generating files, in particular text and audio files, as well as files for computer games and videos.

### BACKGROUND

Automated text generation is known in the art. For example, sports or weather reports, stock market news or traffic information is generated automatically. News portals increasingly rely on robot journalism in their content mix and online shops use computer-generated copy to advertise products. Smart applications create automated individual reports, such as business reports, real estate exposes or fund reports. In this case, AI-based software is capable of efficiently generating and providing linguistic content in real-time.

A necessary condition for creating the automatically generated kinds of text listed above is structured data, i.e. information in tabular form. In the case of weather reports, for example, this would include information on temperature, air pressure or precipitation probability at a given location. Human readers find pure numerical columns of this kind less straightforward to read than running text.

In order to improve the user experience, specific software translates the data into text. This involves the information being inserted into content-relevant parts of an intelligent text template.

Computer-generated articles of this kind based on intelligent templates are used in the online presence of leading media or also in local portals. Another method for text generation is the generation of text through Language Models, which learn a model of language with the help of a Neural Network based on a large training corpus. On the basis of this learned model, they can generate texts similar to the training corpus. However, Language Models of this kind typically only continue from an initial prompt.

### SUMMARY OF THE INVENTION

One aspect of the invention relates to expanding the scope of application and develop a method for generating files, in particular text and audio files, as well as files for computer games and videos, which allows the processing of substantially larger and more diverse data sets than the highly specialized template-based methods permit.

Existing data (text data) is filtered, prepared (cleaned) and physically normalized via a Pre-processing Pipeline. A training corpus tailored to meet the desired results is produced from the prepared data and the training is launched according to predetermined parameters. A file, for example text, is generated from the trained models, wherein delivery takes place via various APIs (Application Programming Interfaces).

Normalization is a technical process, as is known from the audio domain (enlarging or reducing amplitudes), for example, or during the production of fine-grained structures in the manufacture of steel.

Advantageous embodiments of the invention are disclosed herein.

The filtered and prepared (raw) data are represented and compared or processed in individual tokens or digits while maintaining the information content of the original representation of the digit sequences.

### DETAILED DESCRIPTION

The invention is described in greater detail below in an exemplary embodiment.

During pre-processing, files, in the example texts, are filtered, cleaned, and normalized based on linguistic and content parameters. Outlier texts, which significantly deviate from the average linguistically (e.g. due to an extremely high number of function words without substantive meaning), are removed. Undesired or inappropriate content is also removed. The texts are cleaned by removing or correcting authors' comments, stylistic peculiarities (for example, formatting or unusual linguistic variants), characters from non-Latin alphabets and common spelling errors.

Special characters such as quotation marks or dividing lines, but also numerical sequences which are difficult for neural networks to process, are standardized. Sentence splitting and tokenization—in other words, the marking of sentences and word units—are performed.

Sentence splitting is done using the spacy library, with additional rules for parsing normalized symbols for paragraphs, quotation marks, etc. Tokenization, cleaning, filtering, and normalization are entirely based on their own rules and regular expressions, resulting in an exceptionally clean and homogeneous corpus. The high standardization and thorough cleaning lead to a measurable improvement in the text output of models trained on these texts.

The CorpusComposer (module) compiles a training corpus from a pre-processed text corpus. The texts to be considered can be filtered based on metadata, such as text length, for example. Adjustments are made to the model to be trained, such as replacing unintended special characters or subword encoding. Furthermore, the desired input sequences can be defined and control tokens are added. While previous Language Models typically only continue a single input sentence, the invention additionally allows the input of prompts, titles, summaries and end sentences. Control tokens control the text length or genre, for example.

The transformers and fairseq libraries are used for subword encoding and the binarization of corpora for the training of sequence-to-sequence models. Creating a training corpus is otherwise based on custom filters and processing rules. The CorpusComposer allows comfortable configuration for assembling a training corpus and the result is reproducible.

Training is carried out using the aforementioned transformers (Language Models) and fairseq (sequence-to-sequence models) libraries. The Storymodel contains finished shell scripts that can be adapted to the training being launched (paths, hyperparameters).

The StoryGenerator module is responsible for generation. In this case, contexts and specifications for story properties are provided and stories are therefore produced.

The basis of this is extended text generation from the transformers and fairseq libraries. Additional decoder features include, among other things, a blocklist that prevents the generation of certain words or phrases. There are options for a basic and an extended blocklist and the ability to include model-specific blocklists. Furthermore, a reduction in the frequency of repetitions and direct speech and specifying the desired mood of the story is possible. The tension curve can also be influenced there. In some models, character names can also be specified. These models were trained on generalized variants of our corpora containing entity classes (e.g. protagonist, love interest or person) rather than individual names. These can be replaced with desired names after generation. Many known problems associated with machine-generated text are overcome by the additional features and a high baseline quality is achieved with the linguistic output. In addition, they allow greater control over the generated stories.

Rules and formulated knowledge are used to address the problem that neural networks are black boxes with difficult-to-influence output. This improves character learning by analyzing roles and giving equal placeholders to all characters in training stories (instead of names). The tension curve in training stories is analyzed and information on this is provided in training, in order to influence the tension during generation. The implicit world knowledge present in the model is expanded by integrating tabular knowledge and examples that the model can access in the training data. Likewise, explicitly formulated knowledge from knowledge graphs should also be integrated into the training or decoder, allowing both factually correct texts to be generated, on the one hand, and, on the other hand, influence can also be taken through story graphs on facts relevant to a story (or a model), such as specific aspects of the setting, for example.

Semi-automated tests are conducted before each upgrade of the API to ensure that the new version functions as expected.

The generated texts are used for the automatic generation of further forms of entertainment through format-specific technical interfaces. In this case, text-to-video and text-to-game interfaces can be developed in particular.

Having a well-documented Application Programming Interface (API) is a significant advantage for a software or hardware product containing the software, as it enables users to create additional software for the system. This in turn enhances the attractiveness of the initial system, for example a computer system. Long-term stability of the API is another factor.

Storytelling AI has also been developed that writes, for example, English short stories of up to 1,000 tokens.

The applicant's training corpus contains approximately 700,000 short stories, each with a maximum of 1,000 tokens, normalized, and filtered based on linguistic and content parameters. Outlier texts, as well as pornographic, violent, racist, and highly political content, are removed during this. The stories are cleaned or corrected by removing authors' comments, stylistic peculiarities, characters from non-Latin alphabets and common spelling errors. Special characters are standardized.

In addition, the user can also specify a prompt, title, summary and ending as context. The desired text length is determined using control tokens learned during training. Furthermore, the sampling architecture has been expanded with custom algorithms that forbid unwanted word sequences through a blocklist, reduce repetitions more selectively and control the frequency of direct speech and the desired mood (through sentiment scores). With some models, personal names can also be specified, since they were trained on generalized versions of the corpora containing entity classes instead of individual names. These names can be de-anonymized into desired names after generation.

Based on regularly collected human annotations, the applicant has developed automated QA, in order to pre-filter the generated stories and accelerate the model selection process using its own metrics and discriminators.

1-5. (canceled)

6. A method for generating files wherein in a first step, existing data is filtered, prepared, and cleaned, and subsequently a training corpus tailored to meet desired/intended results is produced from the prepared data, wherein the filtered and prepared data are normalized.

7. The method according to claim 6, wherein the data are disassembled, represented, compared, and processed as individual tokens or digits for normalization.

8. The method according to claim 6, wherein new data is generated from the training by means of the normalized data.

9. The method according to claim 6, wherein the files are texts, audio formats, or videos.

10. The method according to claim 6, wherein the data and file generation are carried out via at least one API.

11. The method according to claim 7, wherein the data are disassembled, represented, compared, and processed as individual tokens or digits for normalization.

12. The method according to claim 11, wherein new data is generated from the training by means of the normalized data.

13. The method according to claim 12, wherein the files are texts, audio formats, or videos.

14. The method according to claim 13, wherein the data and file generation are carried out via at least one API.
